(19) United States
(12) Patent Application Publication
(10) Pub. No.: US 2026/0131473 A1
(43) Pub. Date: May 14, 2026

(54) METHOD FOR CONTROLLING AN ARTICULATED ARM WITH A MOBILE REMOTE CONTROL UNIT LOCATED SPATIALLY DISTANT THEREFROM, AND SUCTION EXCAVATOR

(71) Applicant: RSP GMBH & CO. KG, Saalfeld (DE)

(72) Inventors: Alexander KULIK, Weimar (DE); Anne GRABER, Saalfeld (DE); Patrick RENGER, Saalfeld (DE)

(21) Appl. No.: 19/119,647

(22) PCT Filed: Oct. 19, 2023
(86) PCT No.: PCT/EP2023/079192

§ 371 Date: Apr. 9, 2025

(30) Foreign Application Priority Data
Oct. 23, 2022 (DE) 10 2022 127 966.9

(51) Int. Cl. B25J 9/16; B25J 5/00; B25J 13/00; E02F 3/88; E02F 3/90; E02F 3/92; G01B 11/00

(52) U.S. Cl. CPC B25J 9/1692; B25J 5/007; B25J 13/006; E02F 3/8825; E02F 3/905; E02F 3/907; E02F 3/9243; G01B 11/005

(57) ABSTRACT

A method for controlling an articulated arm with a mobile remote control unit located spatially distant therefrom employs a machine coordinate system which is linked to the articulated arm, and an input coordinate system which is linked to the remote control unit. A deviation between the spatial orientation of the input coordinate system relative to the spatial orientation of the machine coordinate system is determined. A target movement direction and target movement speed of the end piece of the articulated arm in the input coordinate system are detected via control elements of the remote-control unit. The target movement direction is transformed into a transformed movement direction using the determined deviation. The transformed movement direction and the movement speed are transmitted to an articulated arm control unit for controlling a drive unit of the articulated arm.

### CROSS-REFERENCE TO RELATED APPLICATION

This application is a 371 National phase of PCT/EP2023/079192, filed 19 Oct. 2023, which claims the benefit of German Application No. 10 2022 127 966.9, filed Oct. 23, 2022, the contents of which are incorporated herein by reference.

### BACKGROUND OF THE APPLICATION

The invention relates, first, to a method for controlling an articulated arm using a mobile remote control unit spatially distant therefrom. Such an articulated arm can be used on different, preferably mobile, work machines, in particular as a component of a suction excavator, namely as an articulated hose carrier. The invention thus also relates to a suction excavator with a remote-controlled articulated hose carrier.

A suction excavator is a vehicle having a vehicle frame that supports a material-collecting container, preferably one that can be tilted.

Multi-joint articulated arms are used in many machines to bring an end piece or end effector (e.g. drill head, suction nozzle or lifting platform) into a specific position and orientation, or to move it along a defined path. The machine-adjacent operation by controlling the pressure in hydraulic cylinders or similar drives to move individual links of the articulated arm is relatively difficult for the user to learn and is prone to errors. In addition, specific requirements must be met such as keeping the end piece in a defined orientation or ensuring an optimal distribution of the bending angles of individual joints.

From DE 38 37 670 A1, a suction excavator is known, comprising a pneumatic suction nozzle, a collection container for the sucked-up soil, into which the suction nozzle opens and in which the soil is deposited from the suction air flow, and a suction blower connected to the collection container for generating the suction air flow.

DE 198 51 111 C1 describes a suction excavator with a collection chamber arranged at the front in the direction of travel in the material collection container, and a filter arranged at the rear in the direction of travel.

Two variants have become established for guiding the suction hose of a suction excavator: the telescopic hose carrier and the articulated hose carrier which is a special design of an articulated arm. The telescopic hose carrier only guides the hose partially so that the suction nozzle at which the material is picked up must be guided manually by an operator. For several years, the articulated hose carrier (also known as a power arm, guide arm or articulated boom) has therefore been preferred. It offers the advantage of complete hydraulic guidance and good stability. This enables more precise control of the working movements without manual exertion of force and using a preferably mobile remote control unit that can be carried by the operator.

A suction excavator with a remote-controlled articulated boom is known from DE 90 16 448 U1. The suction head can be controlled into a desired suction position using individual controls, by means of hydraulic pressure cylinders via a remote control unit.

JP 2010-228905 A describes a remote control and a method for controlling machines.

CN 1 02 561 700 A describes a machine control technology, namely a mechanical arm control system as well as a method and a machine therefor. The mechanical arm to be controlled consists of at least two links. The machine includes a drive unit, a remote control and a direction adjustment unit. The control method provides for the use of two coordinate systems, with one coordinate system being assigned to the remote control and the other coordinate system being assigned to the last link of the arm. Using the example of a concrete pump, it is further described how the horizontal rotation between the machine platform of the multi-joint arm and the remote control can be compensated by measuring the Earth's magnetic field as a common reference direction. As an alternative to the Earth's magnetic field, the measurement of two reference points is proposed. Deviations in the orientation of the two coordinate systems can be offset as long as they can be related to a common reference plane. In practice, however, it turns out that neglecting a possible vertical tilt of the two coordinate systems relative to each other, i.e. when the two coordinate systems are not in a common reference plane, leads to incorrect inputs, which makes the control imprecise.

DE 10 2016 106 427 A1 describes a method for controlling the movement of an articulated hose carrier with a plurality of links, wherein an angle change can be effected between adjacent links by means of a drive. The starting position of the links is ascertained using sensors, a direction vector and a speed parameter are read in, and a target position is determined which a suction crown is to assume at the free end of the last link. Subsequently, the angle changes to the links that must be carried out in order to reach the target position are determined in such a way that the suction crown moves along a straight path to the target position. The drives assigned to the links are controlled to bring about the previously determined angular change at the links. This is followed by a cyclic repetition of the above-mentioned method steps until the direction vector and/or the speed parameter are equal to zero.

Although the operation of an articulated arm, in particular an articulated hose carrier, is significantly simplified with the method described in DE 10 2016 106 427 A1 since the user no longer has to directly control numerous individual drives of the articulated hose carrier but can for example specify a direction vector by deflecting a joystick on the remote control unit which the control unit then converts into control signals for the individual drives, the difficulty remains that the operator has to determine this direction vector himself in relation to the position assumed by the suction nozzle. For example, if the operator is for example at an angle of 90° to the plane of movement of the articulated hose carrier, he must move the joystick at a right angle to the plane for a movement of the suction crown in this plane since the direction vector entered by the user in the remote control does not take into account the position or orientation of the mobile remote control unit. This still requires much practice and good spatial abstraction skills on the part of the user for correct controlling. In telematic application scenarios, this challenge can be further exacerbated by the free choice of perspective by the operator (e.g. perspective from above), scaling (e.g. thumbnail view for an overview or magnification for a more detailed view) and restricted visibility (e.g. limited opening angle of a camera), since the orientation of the reference coordinate systems of machine control and user inputs can differ considerably and in all dimensions from each other.

### SUMMARY OF THE INVENTION

One object of the invention, based on DE 10 2016 106 427 A1, is to provide an improved method for controlling an articulated arm, in particular an articulated hose carrier, with a mobile remote control unit spatially remote therefrom, with which operation is facilitated and thus also possible for largely unexperienced users. Furthermore, the invention is intended to provide a suction excavator for carrying out such a method.

This object is achieved by a method according to the appended claim 1 and by a suction excavator according to claim 12.

The method according to the invention for controlling an articulated arm with a mobile remote control unit spatially distant therefrom initially comprises the following steps: a stationary machine coordinate system is defined which is linked to the articulated arm or the machine unit carrying it (suction excavator). The machine coordinate system is (quasi-) stationary during operation, as long as the location of the machine unit is not moved. Typically, however, the machine coordinate system is rotated to any extent from the input coordinate system of the remote control as well as from generic reference directions such as gravity and the Earth's magnetic field. The movement of the articulated arm can be represented for example by vectors in the machine coordinate system. In this way, the position of at least one end piece at the free end of the articulated arm can be determined in this machine coordinate system, preferably as the end point of a direction vector. For example, on a suction excavator, a suction nozzle serves as the end piece; on other units, the end piece can be formed by a tool, a gripper, a piece of pipe or a similar element that is to be positioned at a work site for a work task to be carried out.

In a further step, a dynamic input coordinate system is defined which is linked to the mobile remote control unit. During operation, situations may thus arise in which the stationary machine coordinate system of the articulated arm has the same orientation as the dynamic input coordinate system of the remote control unit; however, these two coordinate systems will usually not coincide so that there is a deviation in one or more coordinates.

After the two coordinate systems are defined, a deviation between the spatial orientation of the input coordinate system and the machine coordinate system is determined. This deviation can be determined for example as a deviation vector or a transformation matrix. The deviation thus also represents the spatial position of the dynamic input coordinate system within the stationary machine coordinate system, which can therefore also be understood as a higher-level coordinate system. Alternatively, a separate higher-level world coordinate system can be defined in which the orientations of the machine coordinate system and the input coordinate system can be determined and related to each other in order to ascertain a deviation.

In order to initiate a controlled movement of the end piece of the articulated arm, a target movement direction and target movement speed of the articulated arm entered by the user via control elements of the remote control unit are detected in the dynamic input coordinate system, preferably as a target movement vector. For example, the user operates a joystick on the remote control unit, and sensors of the remote control unit detect the speed and direction of the joystick deflection as the target movement vector.

In a subsequent step, the target movement vector or the target motion direction is transformed into the stationary machine coordinate system, using the previously determined deviation between the input coordinate system and the machine coordinate system, to generate a transformed movement vector or a transformed movement direction in the machine coordinate system. This transformation is preferably carried out with the aid of a computing unit which can be part of the remote control unit or the machine unit comprising the articulated arm. The target movement speed then only needs to be transformed if the perspective of the operator has also been scaled in relation to the situation on site at the machine. This can occur in telematic use cases.

Finally, the transformed movement vector is transmitted to an articulated arm control unit which then controls at least one drive unit of the articulated arm in order to move the end piece to the target position specified by the transformed movement vector. This movement can be initiated by controlling one, a plurality of, or all drives on the articulated arm. A particularly preferred controlling of the articulated arm is described in detail in DE 10 2016 106 427 A1 cited above, which is therefore expressly incorporated in the disclosure of the invention explained here.

It is advantageous that the present invention takes into account regularly occurring tilts between the coordinate systems of the machine (machine coordinate system) and the remote control (input coordinate system). Therefore, the three-dimensional rotations of the machine/vehicle and the remote control are completely measured and, preferably, a reference surface independent therefrom is also determined, e.g. by evaluating the gravitation vector. Compared to the prior art, this leads to a more robust method in which the given reference coordinate system is preferably mutually confirmed by at least two measuring methods in order to enable automatic compensation for the rotation between the input coordinate system and machine coordinate system.

By using a three-dimensional reference coordinate system, the method according to the invention also enables the automatic alignment of the end effector and the reduction of incorrect inputs, e.g. when the relationship between the input coordinate system and the machine coordinate system can no longer be clearly understood due to strong tilting relative to one another.

The articulated arm is preferably an articulated hose carrier which particularly preferably comprises a plurality of supporting structure elements, preferably five or six links (also referred to as carrier portions), hydraulic cylinders for driving the individual carrier portions, and a holder on the frame of the suction excavator structure. Furthermore, a pivot drive is advantageously provided for generating a working radius of the articulated hose carrier.

A suction excavator according to the invention is characterized in that it comprises a control unit for controlling the movement of the articulated hose carrier which is configured to carry out the method according to the invention. Preferably, a material collection container is attached to the suction excavator in such a way that it can be tipped out. Preferably, the suction excavator which carries out the described method for controlling the movement of the articulated hose carrier has a sensor on each link of the articulated hose carrier which is suitable for determining, directly or indirectly, the angle which is established when two adjacent links move about the joint lying between them under the action of an associated drive. The drives are controlled by means of the control electronics in such a way that adjustment angles are created which, within the framework of so-called inverse kinematics, allow the last link (end piece) or the suction crown or the suction nozzle to be moved freely at least in an XY plane, but preferably in a 3D coordinate system. A specification via the control for a change in the position of the suction crown, which represents the end piece, is made in the dynamic input coordinate system of the remote control unit and with subsequent transformation into the stationary machine coordinate system of the articulated hose carrier or the suction excavator. In this way, the suction crown or the end piece of the articulated hose carrier can be brought to the specified position in a targeted and direct manner by the operator using only one control element (e.g. a joystick) and a control input thereon.

The method according to the invention advantageously permits the control of the position of an end piece on a movable articulated arm with any number of links, each with one-dimensional rotation about the joints of the articulated arm, by the direct input of the movement direction and movement speed, preferably as a movement vector [symbol] in the dynamic input coordinate system M_{M} of a mobile remote control unit.

The method described here allows the automation of complex operating procedures based on motion inputs in the dynamic input coordinate system of the remote control unit and thus simplifies the operating processes for the user. The inputs for the desired movement of the end piece are interpreted in the dynamic input coordinate system of the remote control unit and are therefore independent of the relative orientation between the machine and the remote control unit, or of the position and orientation of the user.

In an advantageous embodiment, the input coordinate system of the remote control unit is defined by determining a gravitation vector \vec{G}, wherein the detected target movement direction is corrected to compensate for a deviation between the position of the vertical axis of the remote control unit and the gravitational axis. Knowledge of the gravitation vector, preferably in both coordinate systems, is relevant in order to execute inputs that are desired to be planar on a horizontal plane in the input coordinate system in a planar manner, i.e. orthogonal to the gravitation vector, at the machine or the articulated arm, even if the input coordinate system (i.e. the remote control unit) is inclined relative to the horizontal. This is intended to prevent the end piece from being moved diagonally up or down by a horizontal input vector just because the remote control unit is tilted at the moment of input. Preferably, inputs are only applied when the remote control is tilted less than 45 degrees so that the inputs are interpretable and only the deviating rotation around the gravitational axis is then taken into account. The Earth's magnetic field can for example be used as a reference. The definition of the input vector in the remote control unit is therefore preferably carried out taking into account the gravitation vector in order to determine a target movement direction of the end piece independently of the inclination of the remote control unit relative to the gravitation vector, while the rotation of the remote control unit about the gravitational axis (also known as the yaw angle in aviation) influences the target movement direction.

However, measuring the Earth's magnetic field and gravity can be uncertain or even impossible, for example in construction site situations. The Earth's magnetic field is easily superimposed by local magnetic fields (e.g. from electric motors), and the measurement of gravity is disturbed by local shocks and vibrations. In a modified preferred embodiment, a local reference coordinate system with at least three reference points is therefore used. This reference coordinate system can preferably be integrated into construction site furnishings such as construction fences or the like.

According to a further embodiment, a computational leveling of the rotation in the joint of the end piece is also possible in order to automatically maintain its angle of inclination relative to the gravitation vector or to another reference angle.

According to an advantageous embodiment, the above-mentioned method steps are specified, supplemented and carried out as follows:
at the remote control unit, recording the target movement direction and target movement speed (target movement vector [symbol] ) in the dynamic input coordinate system M_{R};
transforming the target movement vector V_{I} defined in this way into the stationary machine coordinate system M_{M} of the articulated arm;
in the stationary machine coordinate system M_{M}, calculating a new target position of the end piece using a specified time window for the movement;
calculating spherical coordinates (φ, ϑ, r) of this target position;
starting from current values, performing a binary search for a reference angle α_{R} to achieve the length r for predefined ratios of the joint angles α₁ to αₙ;
adjusting the first joint angle do to achieve the correct polar angle ϑ;
adjusting the angle to the end piece de to ensure a constant orientation in the Cartesian stationary machine coordinate system M_{M} of the articulated arm or the machine unit supporting it;
checking all target angles for mechanical accessibility (valid value ranges);
if a target angle is not valid, stopping or recalculating using a new binary search with adjusted angle ratios;
if all target angles are valid, simultaneously adjusting all joint angles by opening the hydraulic valves of the articulated arm in proportion to the remaining deviation from the target angle (and, if necessary, taking into account the existing pressure) in a control loop until all target angles have been reached.

It has been shown above that it is essential for the implementation of the method according to the invention that a deviation between the stationary machine coordinate system of the articulated arm (the machine unit) and the dynamic input coordinate system of the remote control unit is determined and applied in the transformation of the target movement vector. The accuracy of controlling therefore depends on the orientation of the two coordinate systems being precisely determined. This can cause problems, especially in the rough conditions of a construction site. Therefore, preferred embodiments of the invention are presented below which address and solve this partial problem, in particular the precise measurement of the position and orientation of the remote control unit, the end piece and the position or angle assumed by the individual joints of the articulated arm.

In general, various known 3D measuring systems can be used to detect the measured values in order to collect the required data with high frequency. However, when using construction machinery on construction sites, additional restrictions must be taken into account, such as:
ultrasound-based systems do not work reliably if there is too much noise and too many variable sound reflectors;
electromagnetic systems are disturbed by the metal housings and electric motors of construction machinery;
radio-based systems and radar are imprecise and are disturbed by high local dynamics;
optical systems are easily outshone by sunlight (including infrared); passively illuminated markers are more robust here;
optical systems generally suffer from dust and visual obscuration by moving components, tools and machines; in the dark they require artificial lighting;
mechanical measuring systems are generally susceptible to failures of moving parts, in particular however in environments with strong environmental influences;
inertial sensors are disturbed by vibrations of the machine units when measuring accelerations (e.g. when detecting the gravitation vector), and the measurement of the Earth's magnetic field can be disturbed by local electromagnetic fields, e.g. from electric motors.

In order to overcome the difficulties and limitations mentioned above, various solutions are presented below which can be used individually or in combination within the scope of the invention. They thus represent preferred embodiments which can be used in particular on a suction excavator according to the invention.

Preferably, various measuring systems are used to detect the orientation of the input coordinate system in relation to the orientation of the machine coordinate system, in particular optical measuring systems with which passively or actively illuminated markers can be detected; inertial sensors with which the gravitation vector and the Earth's magnetic field can be determined. The relative orientation can also be adjusted manually by the operator.

To define the input coordinate system, the relative rotation about the gravitational axis of the input coordinate system and of the machine coordinate system is preferably derived from a position measurement of at least two points. For this purpose, optical systems based on passively illuminated markers in the visible light spectrum or laser-based position measuring systems are preferably used. Such systems are known as “Lighthouse”; they are laser-based inside-out position tracking systems. Such systems are described for example in U.S. Pat. No. 10,338,186 B2. Although they use active light (usually infrared), in a pulsed laser this can be bright enough to stand out from sunlight as a signal. However, high-energy lasers also present the risk of blinding people who are standing nearby. The combination of passively illuminated markers and high-resolution cameras in the visible light spectrum is a particularly preferred variant for reasons of work safety and costs.

In addition, a camera can be placed on the machine unit (e.g. suction excavator) which carries the articulated arm, on a stand, on construction site furnishings (e.g. fences), and/or on the remote control unit. However, a single camera does not provide depth information. Therefore, powerful stereo cameras can preferably be installed on a stand and/or on the vehicle.

A camera can be attached to the remote control unit in particular with little effort and can be easily cleaned. A robust acquisition of 3D information can be achieved here by movement, while the detected elements (machine unit, articulated arm links and end piece) remain stationary. The use of optical 3D measuring systems is therefore particularly suitable for rather rare comparative measurements for calibrating other measurements.

A mechanical measuring system is a good option because the articulated arm already provides the basic mechanical structure, and it is also robust enough for rough construction site use. The measurement of the angles between individual joint links can be achieved both mechanically and through the use of inertial sensors. However, the latter can be disturbed by vibrations of the machine unit. These disturbances can be corrected by appropriate low-pass filters, but this also results in a reduction in the achievable recording frequency and thus impairs the control loop for reducing angular errors for the target position of the end piece. When using inertial sensors, the inclination of the entire machine unit must also be taken into account in order to derive correct bending angles of the articulated arm links from the measured gravitation vectors.

A preferred embodiment uses mechanical rotary encoders. A modified embodiment uses hydraulic cylinders with linear position sensors on the articulated arm to determine the position of the individual joints. The resulting bending angles between articulated arm links can also be derived from the deflection of the hydraulics by taking the mechanical geometry into account.

Potential errors from high-frequency mechanical measurements can be detected and corrected by low-frequency measurements from the inertial sensors. It is therefore preferable to combine high- and low-frequency measurements. Optical measurements on passively illuminated markers made (with an even lower frequency) by a camera, preferably in the remote control unit, are also preferably added, in particular for regular calibration of the overall system. In particularly sensitive or critical moments, continuous optical tracking of the end piece can also be carried out.

In a modified embodiment, one or more cameras in the remote control unit can measure the relative orientation of the remote control unit to the end piece of the articulated arm and/or to the vehicle (suction excavator).

The remote control unit can preferably be equipped with a 3D inertial sensor (IMU), just like the entire machine and the end piece. The measurement of the Earth's magnetic field is also relevant for the correct interpretation of the movement inputs. In order to quickly detect disturbances and resulting errors, the values of multiple IMUs can be compared at positions that are as far apart as possible but mechanically firmly coupled.

Preferably, the proposed automatic transformations from the input coordinate system to the machine coordinate system are only applied if the measurement of a common reference coordinate system is confirmed by at least two independent measuring systems.

### BRIEF DESCRIPTION OF THE DRAWINGS

Further details, advantages and developments of the invention are apparent from the following description of preferred embodiments, with reference to the drawing. Shown are:

FIG. 1 is a symbolic representation of a suction excavator that is being operated on a construction site by a user with a remote control unit;

FIG. 2 is a symbolic first representation of an articulated arm and a remote control unit for carrying out a method according to the invention for controlling the articulated arm;

FIG. 3 is a symbolic second representation of the articulated arm to illustrate the position of an end piece relative to a root joint;

FIG. 4 is a graph representation of possible relations between a dynamic input coordinate system of the remote control unit and a stationary machine coordinate system of the articulated arm with the position of the end piece;

FIG. 5 is a flow chart of a process chain for calculating all angles of the articulated arm from a target movement vector in the dynamic input coordinate system;

FIG. 6 is a symbolic third representation of the articulated arm to illustrate the division of angles between the links of the articulated arm;

FIG. 7 is an illustration of the concatenation of vectors to calculate a point and its distance from the root joint.

### DETAILED DESCRIPTION OF THE INVENTION

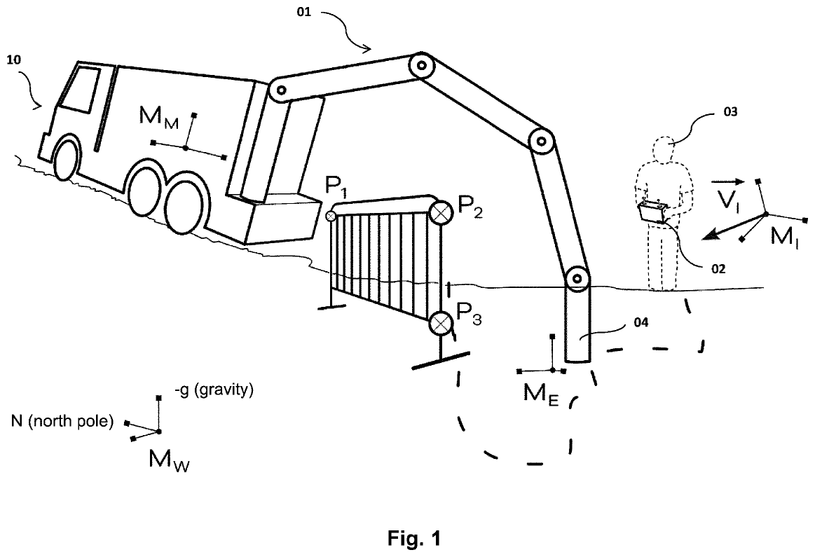

FIG. 1 illustrates a typical application situation in which a suction excavator 10 with an articulated arm 01 is used on a construction site. A stationary machine coordinate system M_{M} of the suction excavator 10, an end effector coordinate system M_{E} of an end effector 04, and a dynamic input coordinate system M_{I} of a remote control unit 02 are rotated three-dimensionally with respect to each other and also deviate from a world coordinate system M_{W} based on the gravitational vector and the Earth's magnetic field. An alternative reference coordinate system can be obtained by measuring three reference points P₁, P₂, P₃ which are attached to construction site furnishings such as construction fences.

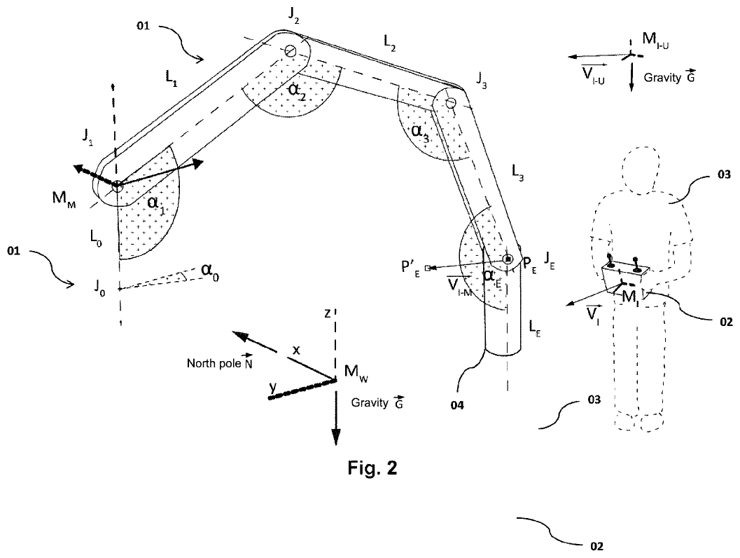

FIG. 2 shows a schematic diagram of the articulated arm 01, which in the embodiment considered as an example below is an articulated hose carrier of a suction excavator (FIG. 1). The articulated arm 01 has a plurality of articulated arm links Lₙ that are connected to each other via joints Jₙ. The remote control unit 02 is provided spatially separated from the articulated arm 01, with which unit a user 03 can control the desired movements of the articulated arm 01. In telematics applications, this can also be out of sight and out of direct range, i.e. at any distance.

The remote control unit 02 and an articulated arm control (not shown) cooperate to carry out the method according to the invention for controlling the articulated arm. Ultimately, the goal is to move the end effector 04 (also called the end piece), which is located at the free end of the articulated arm 01, to a desired target position in order to perform a work task there. In the case of suction excavators, this work task usually involves collecting material, e.g. excavated soil, using the negative pressure generated by a fan unit of the suction excavator, and transporting the material through a suction hose carried by the articulated arm into a material collection container.

In FIGS. 1, 2, 3, 6, 7, coordinate system symbols are shown for easier understanding, wherein coordinate system symbols without arrowheads only represent an orientation but not a relevant position.

The articulated arm links Lₙ rotate around the joints Jₙ. The orientation of the articulated arm 01 is determined in the stationary machine coordinate system M_{M}, while the orientation of the remote control unit 02 is defined in the dynamic input coordinate system M_{I}.

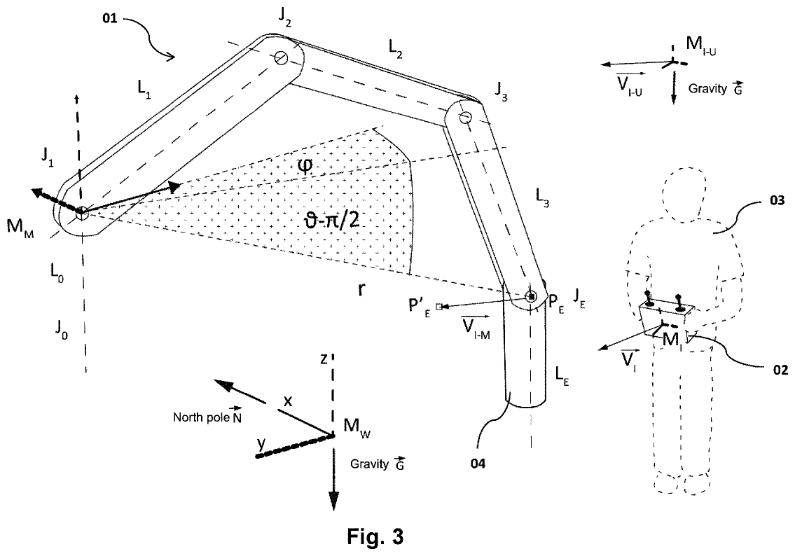

FIG. 3 also shows the basic structure of the articulated arm 01 according to FIG. 2. The angle ranges shown here serve primarily to indicate the position of the end piece 04. The end piece 04 is attached to the last joint J_{E} and can also be understood as an end effector whose position P_{E} lies at the last joint J_{E}. The movement of the position P_{E} of the end effector is shown in FIG. 3 in spherical coordinates (φ, ϑ, r) relative to the root joint J₀ or also to the first joint J₁ which can only be rotated about the Z-axis on the suction excavator relative to the root joint J₀ (no change in angle between J₀ and J₁). The following explanations of the execution of the method also refer to this type of representation.

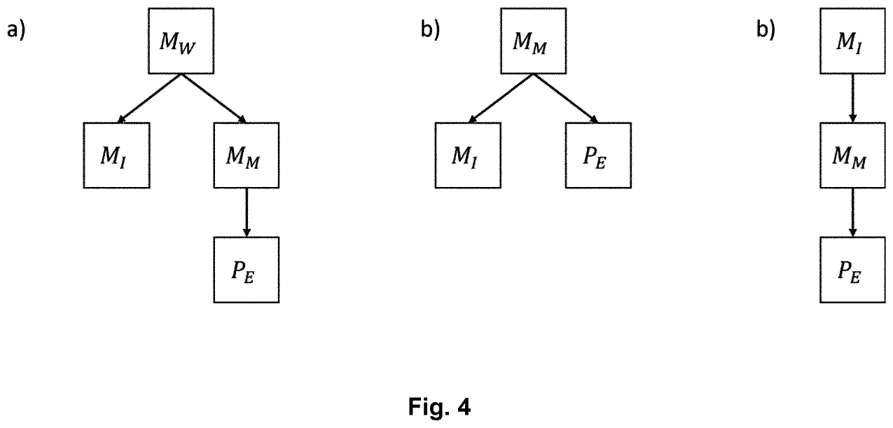

The following assumptions are made for the functional implementation of the method for controlling the articulated arm in the embodiment of the articulated hose carrier of a suction excavator:
a) The articulated arm 01 consists exclusively of one-dimensional rotation joints Jₙ, where all joints J₁ to Jᵢ are identically oriented, and an additional rotation with an axis of rotation rotated by 90° is only possible at the root joint J₀ or J₁.
b) The movement of the end effector P_{E} relative to the root joint J₀ or J₁ can be defined in spherical coordinates (φ, ϑ, r), wherein the azimuth angle φ is determined exclusively by the angle of the root joint J₀ at the suspension of the arm, and the angles αₙ of all other joints J₁ to Jᵢ jointly determine the length (or the spherical radius r) and the polar angle ϑ (see FIG. 3).
c) The ratios of the individual joint angles α₂ to αᵢ are predefined by weights w and offsets o (e.g. uniformly distributed) so that the radius r, i.e. the distance of the end effector position P_{E} to the root joint J₁, can be determined by specifying a single reference angle β:

$${α}_{n} = {w}_{n} * β + {o}_{n}$$

where in the following we assume an equal distribution of the angles α₂ to α₅, i.e.: wₙ=1 and oₙ=0.
d) The orientation of the input coordinate system M_{I} of the remote control unit and of the machine coordinate system M_{M} are jointly defined in a higher-level coordinate system (here world coordinate system M_{W}) (see FIG. 4a). Alternatively, M_{I} can also be defined in M_{M} (FIG. 4b), or M_{M} can be defined in M_{I} (FIG. 4c). In addition, the position of the end effector P_{E} has to be defined in the machine coordinate system M_{M}. The following descriptions are based on a spatial structure (FIG. 4a). M_{W} does not have to indicate an original position; a reference frame for orientation is sufficient, e.g. based on gravity and the north pole of the Earth's magnetic field (see FIG. 2 or FIG. 3). Alternatively, a reference coordinate system can be determined by measuring at least three reference points (see P₁-P₃ in FIG. 1).

FIG. 4 shows possible relations between the input coordinate system M_{I} and the machine coordinate system M_{M} with the position of the end effector P_{E} as a graph.

As already explained above, the controlling of at least one drive unit of the articulated arm 01 for moving the end piece 04 or end effector P_{E} to a target position specified by the transformed movement sector using previously known controlling can be done as described for example in DE 10 2016 106 427 A1. Such controlling can also be called inverse kinematics since it always controls the individual joints depending on the target position of the end piece. A possible technical implementation of this inverse kinematics in an articulated hose carrier of a suction excavator can be carried out as follows:
1. The control commands from the remote control unit are first processed algorithmically to indirectly manipulate the oil pressure in the hydraulic cylinders to move the articulated arm links, resulting in controlled movements of the end effector.
2. The articulated arm consists exclusively of one-dimensional rotation joints, wherein all joints are identically oriented, and only the root joint J₀ has an axis of rotation rotated by 90°.
3. The movement of the articulated arm can be defined in spherical coordinates, wherein the azimuth angle φ is determined exclusively by the angle of the root joint J₀ at the suspension of the arm, and the angles of all other joints Jₙ together determine the length (or the spherical radius r) and the polar angle ϑ.
4. The ratios of individual joint angles are predefined (e.g. evenly distributed) so that the desired arm length r can be determined by specifying a single angle value.
5. The angles of the articulated arm links are detected simultaneously using different sensors and measuring methods in order to eliminate the given systematic measurement errors. Preferably these are two or more of the following sensors:
a. angle sensors in the joints of the multi-link articulated arm;
b. linear position sensors in the hydraulic cylinders;
c. inertial sensors for measuring the gravitation vector;
d. camera-based or laser-based sensors for the absolute measurement of position and orientation of the individual articulated arm links, including the end effector, relative to an external measuring station, e.g.:
i. on the machine,
ii. mobile on a stand or integrated into construction site furnishings such as fences,
iii. mobile on the remote control unit.
6. The relative orientation of the articulated arm and the remote control unit is detected by a combination of sensors in order to eliminate systematic measurement errors here as well. These are preferably:
a. 3D inertial sensors in or on the remote control unit and on the articulated arm;
b. redundant 3D inertial sensors with the greatest possible distance and immovable mechanical connection to detect and evaluate interference effects of local magnetic fields on the electronic compasses.
c. camera-based or laser-based sensors for absolute measurement of the orientation of the remote control unit, articulated arm and end effector relative to each other or relative to an external measuring station, e.g.:
i. on the machine,
ii. mobile on a stand or integrated into construction site furnishings such as fences,
iii. mobile on the remote control unit.
7. The position of the end effector is detected simultaneously using two measuring methods to detect systematic measurement errors. These are preferably:
a. mechanical measurement of the end effector based on the orientation of all links of the articulated arm;
b. camera-based or laser-based sensors for absolute measurement of the orientation of the remote control unit, articulated arm and end effector relative to each other or relative to an external measuring station, e.g.:
i. on the machine,
ii. mobile on a stand or integrated into construction site furnishings such as fences,
iii. mobile on the remote control unit.

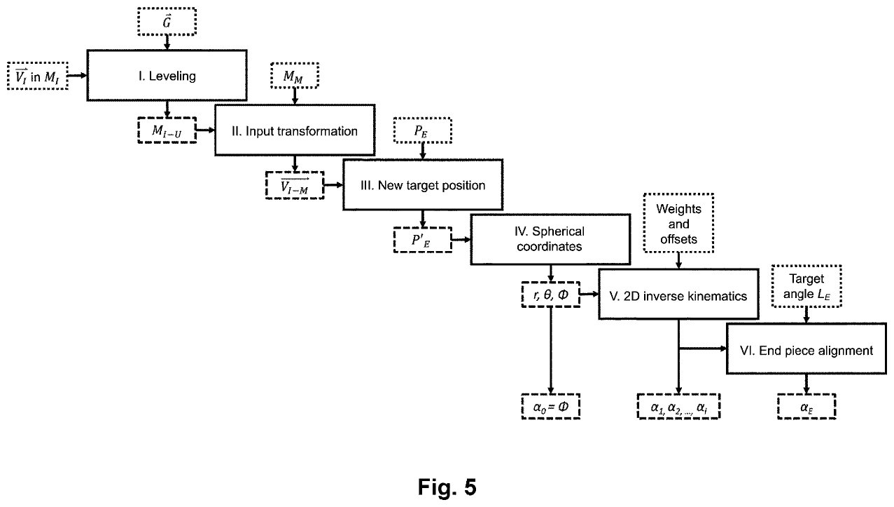

FIG. 5 shows a flow chart of the process chain for calculating all angles αₙ of the articulated arm 01 from a target movement vector \vec{V_{I}} detected in the remote control unit 02 in the input coordinate system M_{I}. The control commands of the remote control unit 02 are processed in the sequence shown in FIG. 5 in order to ascertain all target angles αₙ of the joints Jₙ so that a controlled movement of the end effector P_{E} along a transformed movement vector [symbol] results. In so doing, the target movement vector [symbol] is transformed into the transformed movement vector using the previously determined deviation between the input coordinate system M_{I} and the machine coordinate system M_{M}. One possibility of this transformation is explained in detail below for the case of mapping M_{M} and M_{I} in a common reference coordinate system M_{W} (see FIG. 4a):
I. Leveling (optional): the target movement vector [symbol] is given in the input coordinate system M_{I} of the remote control unit. Before the transfer (transformation) of [symbol] into the machine coordinate system M_{M}, the input coordinate system M_{I} is aligned or leveled according to the previously ascertained gravitation vector [symbol] so that only the rotation of the remote control unit 02 about the gravitational axis needs to be taken into account. For this purpose, a new leveled input coordinate system M_{I-U} is constructed in the following sub-steps:
1. First, it is checked whether the input coordinate system M_{I} is inclined by less than 90° to the gravitation vector [symbol] , i.e. that the scalar product of a unit vector along the z-axis of the input coordinate system [symbol] =(0, 0, 1) with the inverse of the normalized gravitation vector Ĝ=( [symbol] )/∥ [symbol] ∥ in a common world coordinate system M_{W} is less than zero, i.e. the two point in different directions:

$$\hat{G} * ( {M}_{I} * ) < 0$$

(under the assumption that [symbol] is already defined in the world coordinate system M_{W}).

Otherwise, the remote control unit is tilted downwards, and no clear interpretation of the input vector is possible. In this case, the control of the articulated arm should be interrupted.
2. If the precondition Ĝ*(M_{I}* [symbol] )<0 is fulfilled, the axes of the leveled input coordinate system M_{I-U} are constructed by calculating cross products between the x- or y-axis of the input coordinate system and the gravitation vector (in the common world coordinate system M_{W}) (here using the example of the y-axis, i.e. a unit vector along the y-axis [symbol] ).

$$= ( {M}_{I} * \hat{{y}_{I}} ) \times {\hat{G}}^{- 1} \\ = \times {\hat{G}}^{- 1} \\ = {\hat{G}}^{- 1}$$

3. To accordingly level the target movement vector [symbol] , it is simply expressed with identical values in the leveled input coordinate system M_{I-U}.

$$\vec{{V}_{I - U}} = \vec{{V}_{I}}$$

II. Input transformation: The input vector V_{I} or the leveled input vector V_{I-U} can now be expressed in the machine coordinate system using the following calculation rule:

$$\vec{{V}_{I - M}} = {M}_{M}^{- 1} * ( {M}_{I - U} * \vec{{V}_{I - U}} )$$

III. New target position: if the current position of the end effector is known as a point P_{E} in the machine coordinate system M_{M}, the new target position P′_{E} can be calculated by being moved along the transformed movement vector in the machine coordinate system.

$${P}_{E}^{′} = {P}_{E} + \vec{{V}_{I - M}}$$

IV. Spherical coordinates: the target position of the end effector must be converted into spherical coordinates

$$r = \sqrt{{x}^{2} + {y}^{2} + {z}^{2}}$$

$$φ = \{ \begin{matrix}{cos}^{- 1} \frac{x}{\sqrt{{x}^{2} + {y}^{2}}} for y \geq 0 \\ 2 * π - {cos}^{- 1} \frac{x}{\sqrt{{x}^{2} + {y}^{2}}} for y < 0\end{matrix}$$

$$ϑ = {tan}^{- 1} \frac{z}{\sqrt{{x}^{2} + {y}^{2}}}$$

The orientation of the machine coordinate system must be taken into account, and the resulting angle values must be shifted by a multiple of π/2 as necessary. Alternatively, all three values of the spherical coordinates can also be ascertained by vector calculations. The radius r, or the distance of the target position P′_{E} from the root joint J₁, is the length of the vector between the two points.

$$r = ‖ \vec{{J}_{1} {P}_{E}^{′}} ‖$$

The pivot angle α₀=φ is the scalar product of a unit vector along a reference axis in the machine coordinate system M_{M} (e.g. the x-axis [symbol] in FIGS. 2 and 3) and the normalized projection of [symbol] onto the horizontal plane of the machine coordinate system M_{M} (e.g. the x/y plane in FIGS. 2 and 3). For the projection of [symbol] onto the desired plane, the vector component of the dimension to be ignored (e.g. z) can be set to zero. The projection can be written using cross products, e.g.:

$$φ = ( ( \times ) \times ) * - 1 *$$

ϑ is the scalar product of a unit vector along a reference axis in the machine coordinate system M_{M} (e.g. the z-axis [symbol] in FIGS. 2 and 3) and the normalized vector [symbol] in the machine coordinate system M_{M}.

$$ϑ = *$$

The pivot angle is already given as a result of this method step:

$${α}_{0} = φ$$

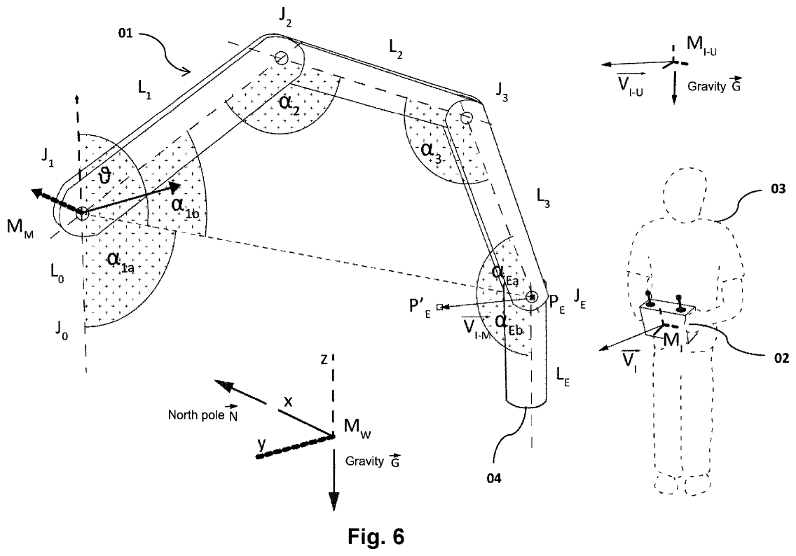

If P_{E}=J_{E}, the vector [symbol] divides the angle α₁ into the components α₁ₐ and α_{1b} as well as α_{E} into α_{Ea} and α_{Eb} (see FIG. 6), where the following holds:

$${α}_{1 a} = π - ϑ$$

$${α}_{1 b} = {α}_{1} - {α}_{1 a}$$

V. 2D inverse kinematics: the calculation of the angles α₁ bis αᵢ can be solved in a two-dimensional coordinate system since all joints J₁ to Jᵢ lie on the same plane and rotate around parallel axes. The sizes of the angles α₁ bis αᵢ together with the lengths of the adjacent links L₁ to Lᵢ define the length of the vector [symbol] . What is sought are the angles α₁ bis αᵢ with which the following applies:

$$‖ \vec{{J}_{1} {J}_{E}} ‖ = ‖ \vec{{J}_{1} {P}_{E}^{′}} ‖$$

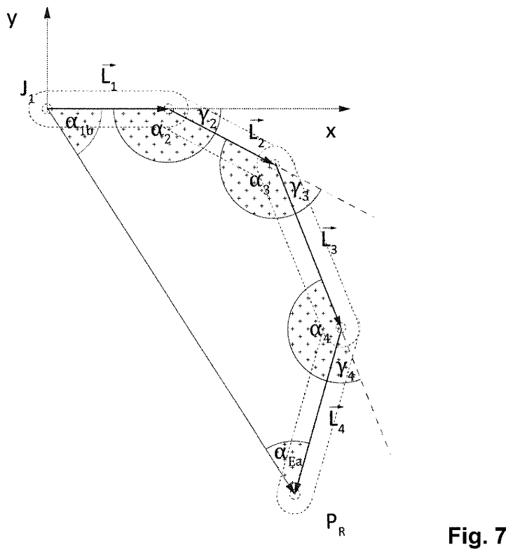

An analytical solution only exists in special cases. As a generic solution path for a virtually arbitrary number of links, varying ratios of the angles α₂ bis αᵢ, and different lengths of the adjacent links L₁ to Lᵢ, the following possible solution path is described:
1. The geometric relationships of the length-relevant links L₁ to Lᵢ are expressed in isolation in an independent 2D coordinate system, where L₁ is aligned to the x-axis (since α₁ has no influence on the vector length [symbol] ; see FIGS. 6 and 7).
2. Each of the length-relevant links L₁ to Lᵢ is now expressed as a 2D vector in this coordinate system and rotated corresponding to the angle αₙ with γₙ=αₙ−π (see FIG. 7). For L₁, γ₁=0 applies here since L₁ is aligned along the x-axis.

The coordinates of the vectors [symbol] to [symbol] are each calculated as follows (with l₁ to lᵢ as the lengths of the links L₁ to Lᵢ):

$${x}_{{L}_{2}} = l cos ( {γ}_{1} )$$

$${y}_{{L}_{1}} = l sin ( {γ}_{1} )$$

$${x}_{{L}_{2}} = l cos ( {γ}_{1} + {γ}_{2} )$$

$${y}_{{L}_{2}} = l sin ( {γ}_{1} + {γ}_{2} )$$

$$⋯$$

$$⋯$$

$${x}_{{L}_{i}} = l cos ( {γ}_{1} + {γ}_{2} + ⋯ + {γ}_{i} )$$

$${y}_{{L}_{i}} = l sin ( {γ}_{1} + {γ}_{2} + ⋯ + {γ}_{i} )$$

3. From the concatenation of the resulting 2D vectors [symbol] to [symbol] , a point P_{R} results (see FIG. 7).

$${P}_{R} = \vec{{L}_{1}} + \vec{{L}_{2}} + ⋯ + \vec{{L}_{l}}$$

4. The next task is to find the appropriate values γₙ for which the distance [symbol] corresponds to the target distance [symbol] . All values γₙ are defined by a common reference angle β, because γₙ=αₙ−π and αₙ differ from β only by predefined weights wₙ and offsets oₙ.

$${α}_{n} = {w}_{n} * β + {o}_{n}$$

To search for the right β, a binary search algorithm is used. In addition to the global parameter limits βₘᵢₙ and βₘₐₓ, here local limitations αₙ₋ₘᵢₙ and αₙ₋ₘₐₓ also have to be taken into account. As needed, local weights wₙ and offsets on enable an optimization of the range of motion of the entire articulated arm.
5. From the found value of β, taking into account the local weights wₙ and offsets oₙ, all angle values from α₂ to αᵢ can now be derived. α₁ is composed of α₁ₐ, which was already found in step IV during the translation into spherical coordinates, and α_{1b}. The latter is the angle, i.e. the scalar product between the normalized vector [symbol] and a unit vector along the x-axis of the auxiliary coordinate system used here:

$${α}_{1 b} = * \hat{x}$$

VI. Alignment of end piece: to calculate the last remaining angle α_{E}, after ascertaining [symbol] and the individual vectors [symbol] to [symbol] , a part is also already calculable:

$${α}_{E a} = *$$

α_{Eb} can be described as a scalar product of [symbol] and a vector in the target orientation of the last link [symbol] . Since the latter is defined relative to a vector in the reference coordinate system, e.g. the gravitation vector [symbol] , we use its normalized representation in the machine coordinate system M_{M} as a reference:

$${α}_{E b} = * ( \hat{G} * {M}_{M}^{- 1} )$$

Desired deviations of the orientation of [symbol] from the gravitation vector [symbol] can then be directly offset against the ascertained angle α_{E}.

FIG. 6 shows the division of α₁ into α₁ₐ and α_{1b} and of α_{E} into a α_{Ea} and α_{Eb} by the vector [symbol] . The length of the vector [symbol] is determined by the lengths of the links L₁, L₂, L₃ and the enclosed angles α₂ and α₃.

FIG. 7 shows the concatenation of the vectors [symbol] to [symbol] for the calculation of a point P_{R} and its distance from the root joint J₁.

1. A method for controlling an articulated arm with a mobile remote control unit spatially remote therefrom, comprising the following steps:
defining a machine coordinate system (M_{W}) which is linked to the articulated arm so that the position of at least one end piece at the free end of the articulated arm can be determined in this machine coordinate system;
defining an input coordinate system (M_{I}) which is linked to the remote control unit;
determining a three-dimensional deviation between the 3D spatial orientation of the input coordinate system and the 3D spatial orientation of the machine coordinate system;
detecting a target movement direction and target movement speed of the end piece of the articulated arm in the input coordinate system input via operating elements of the remote control unit;
transforming the target movement direction into a transformed movement direction using the determined 3D deviation between the input coordinate system (M_{I}) and the machine coordinate system (M_{M});
transmitting the transformed movement direction and the movement speed to an articulated arm control unit, and controlling at least one drive unit of the articulated arm to move the end piece to the specified target position.

2. The method according to claim 1, wherein the input coordinate system of the remote control unit is defined by determining a reference plane, wherein the detected target movement direction is corrected in order to compensate for a deviation between the position of the vertical axis of the remote control unit and the reference axis located on the reference plane.

3. The method according to claim 2, wherein the reference plane is determined on the basis of a gravitation vector, wherein the detected target movement direction is corrected in order to compensate for a deviation between the position of the vertical axis of the remote control unit and the gravitational axis.

4. The method according to claim 1, wherein the target movement direction and the target movement speed of the end piece are detected as a target movement vector in the input coordinate system; and that the target movement vector is transformed into a transformed movement vector using the determined deviation between the input coordinate system and the machine coordinate system; and that the transformed movement vector is transmitted to the articulated arm control unit.

5. The method according to claim 4, wherein spherical coordinates of the target position are calculated based on the transformed movement vector in the machine coordinate system.

6. The method according to claim 1, wherein the transformation from the input coordinate system to the machine coordinate system is carried out taking into account the determined three-dimensional deviation only if the three-dimensional deviation between the 3D spatial orientation of the input coordinate system and the 3D spatial orientation of the machine coordinate system is confirmed by measurements with at least two independent measuring systems.

7. The method according to claim 1, wherein to define the input coordinate system, its orientation in relation to the machine coordinate system is measured, preferably using one or more measuring systems from the following list:
optical measuring systems with which passively or actively illuminated markers can be detected;
inertial sensors that can be used to determine the gravitation vector and the Earth's magnetic field.

8. The method according to claim 1, wherein in order to define the input coordinate system, the relative rotation about the gravitational axis of the input coordinate system and the machine coordinate system is derived from a position measurement of at least three points, preferably using one or more measuring systems from the following list:
laser-based position measuring systems, preferably with pulsed light;
optical measuring systems with which passively or actively illuminated markers can be detected;
stereo cameras that are preferably arranged on the machine unit carrying the articulated arm or on stationary construction site furnishings;
one or more cameras that are arranged on the remote control unit or on stationary construction site furnishings.

9. The method according to claim 1, wherein position measurements are carried out to determine the position of the end piece, preferably using one or more measuring systems from the following list:
optical measuring systems with which passively or actively illuminated markers can be detected;
laser-based position measuring systems, preferably with pulsed light;
stereo cameras that are preferably arranged on the machine unit carrying the articulated arm;
one or more cameras that are arranged on the remote control unit;
a mechanical measuring system on the articulated arm, preferably with rotary encoders;
inertial sensors on the joints of the articulated arm and/or on the remote control unit.

10. The method according to claim 1, wherein the Earth's magnetic field is measured and taken into account to define the input coordinate system and the machine coordinate system.

11. The method according to claim 1, wherein the articulated arm is a component of one of the following devices:
suction excavator;
concrete pump;
sewer cleaning machine;
sewer inspection machine;
drill;
lifting platform.

12. A suction excavator with a vehicle frame, a fan unit for generating a suction flow for picking up material, a filter unit, a material collection container for collecting the picked-up material, a multi-link articulated hose carrier, and with a mobile remote control unit for controlling the movement of the articulated hose carrier, characterized in that a control unit of the suction excavator and the remote control unit are configured to carry out a method of claim 1.
